(19) United States
(12) Patent Application Publication
(10) Pub. No.: US 2006/0275685 A1
(43) Pub. Date: Dec. 7, 2006

(54) Image formation device and image formation process

(75) Inventor: Masatoshi Kimura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/281,694

(22) Filed: Nov. 18, 2005

(30) Foreign Application Priority Data
Jun. 7, 2005 (JP) 2005-167470
Oct. 12, 2005 (JP) 2005-298034

(51) Int. Cl. G03G 13/06; G03G 9/08

(52) U.S. Cl. 430/97; 430/120

(57) ABSTRACT

An image formation device including: a charge conservation member including a transparent conductive substrate, a photoconductive layer formed on the transparent conductive substrate, and microscopic isolated island-form charge sites, numerous microelectrodes for charge conservation being formed on the photoconductive layer to be distributed more finely than individual pixels; a conductive voltage supply member touching the microscopic isolated island-form charge sites; a power source which, when the voltage supply member touches the microscopic isolated island-form charge sites, applies voltage between the transparent conductive substrate and the voltage supply member, for forming an electric field in the charge conservation member; and an exposure section which, in a state in which the electric field is formed in the charge conservation member, performs image exposure from the transparent conductive substrate side of the charge conservation member to form an electrostatic latent image at the microscopic isolated island-form charge sites.

### CROSS-REFERENCE TO RELATED APPLICATION

This application claims priority under 35 USC 119 from Japanese Patent Application Nos. 2005-167470 and 2005-298034, the disclosures of which are incorporated by reference herein.

### BACKGROUND OF THE INVENTION

1. Field of the Invention

The present invention relates to an image formation device and an image formation process, and more particularly relates to an image formation device and image formation process which utilize microscopic isolated island-form charge sites, at which numerous microelectrodes that may be capable of charge conservation are formed on a photoconductive layer to be distributed more finely than individual pixels, and which, by irradiating imaging light at the photoconductive layer, form an electrostatic latent image at the microscopic isolated island form charge sites, without employing a step of charging.

2. Description of the Related Art

Heretofore, an image-forming process has been known which does not employ a step of charging. This image formation process forms an image by the following procedure. (1) voltage is applied between a photoconductor which can be charged to two polarities and a magnetic brush developing apparatus, and optical irradiation is performed in accordance with an image pattern from a side which is opposite from the magnetic brush developing apparatus. Thus, trapped charges are formed at the photoconductor. (2) Thereafter, a voltage opposite to the voltage mentioned above is applied between the magnetic brush developing apparatus and the photoconductor, and toner which is adhered at locations that have not been irradiated with light is removed, thus implementing image formation.

This image formation process will be described in more detail with reference to FIGS. 1A and 1B. As shown in FIG. 1A, a transparent conductive layer 2 and a photoconductive layer 3 are sequentially layered onto a transparent substrate 1 to form a photoconductor. A two-component toner composed of an insulative toner and a carrier is conveyed onto the photoconductive layerphotoconductive layer 3 by a magnetic brush developing apparatus 4. A voltage is applied between a sleeve of the magnetic brush developing apparatus 4 and the transparent conductive layer 2, so as to cause negative electric charges to flow into the transparent conductive layer 2, and induced charges 5 are generated in the transparent conductive layer 2. In this state, light corresponding to an image pattern is irradiated from the direction shown by arrows B at a rear face side of the transparent substrate 1.

Photocarriers are generated inside a portion of the photoconductive layerphotoconductive layer 3 that is exposed, electrons in the carriers are brought to the surface of the photoconductive layerphotoconductive layer 3 by the electric field between the magnetic brush developing apparatus and the transparent conductive layer, and potentials of the transparent conductive layer 2 and the photoconductive layerphotoconductive layer 3 become substantially equal at the exposed portion. That is, developing with the magnetic brush developing apparatus is a developing step similar to developing a metal surface with a development bias voltage. Consequently, at the exposed portion, electric charge of opposite polarity (negative charge) and equivalent quantity to charge held by the developed toner layer is induced at the photoconductive layerphotoconductive layer 3. In this state, when image exposure stops, movement of the carriers substantially ceases, resistance of the photoconductive layerphotoconductive layer 3 rises, and substantially the whole of the photoconductive layerphotoconductive layer 3 becomes an insulator. As a result, the charge induced at the surface of the photoconductive layerphotoconductive layer 3 becomes trapped charge, and is incapable of moving. In contrast, at a non-exposure portion, the photoconductor is developed by the developing bias, via the photoconductive layerphotoconductive layer 3. This is a first development step.

In a second development step, as shown in FIG. 1B, the development bias voltage is set to a bias on the photoconductor opposite to that at the time of the first development step. Accordingly, charged toner at the non-exposure portion starts to be recovered to the developing apparatus 4 by the electric field. At the same time, the charge that has been induced at the transparent conductive layer 2 migrates toward an earth terminal, and the induced charge (electrons) that was left induced at the transparent conductive layer 2 is removed.

Meanwhile, at the exposure portion, a portion of the charged toner is recovered by the action of an electric field between the magnetic brush developing apparatus 4 and the photoconductive layerphotoconductive layer 3. However, because the electrons trapped in the photoconductive layerphotoconductive layer 3 cannot move, charge 6 of the same polarity as toner 7 is induced at the transparent conductive layer 2 in accordance with an amount of charge of the toner that is recovered.

Because capacitance of the photoconductive layerphotoconductive layer is small when optical irradiation is not being performed, a surface potential of the photoconductive layerphotoconductive layer is changed greatly even by a small positive charge. In combination with the development bias voltage, this immediately makes toner at the exposure portion electrostatically unrecoverable. Thus, only the toner 7 at the exposure portion remains, and a toner image is formed.

In this image formation process, trapped charges play a very important role.

Another image formation process has been known which utilizes a photoconductor at which, subsequent to it having been experimentally ascertained how trapped charges are distributed within photosensitive bodies, trapped charge sites are formed by layering a transparent conductive layer and a photoconductive layerphotoconductive layer onto a transparent substrate, which photoconductive layerphotoconductive layer can be charged to two polarities and is covered with a dot-form conduction layer. Charged toner is conveyed to between a first electrode and the photoconductor, voltage is applied between the first electrode and the transparent conductive layer, and exposure in accordance with an image pattern is performed from the transparent substrate side. Thus, the charged toner is adhered to an exposure portion and a non-exposure portion of the photoconductor. At locations of the exposure portion, because of the charge of the charged toner, a flow of charge from the transparent conductive layer through the photoconductive layerphotoconductive layer into the dot-form conduction layer is implemented, and trapped charges are formed in vicinities of the surface of the photoconductive layerphotoconductive layer (a first development step). Thereafter, an exposed region of the photoconductor is conveyed to a position opposing a second electrode, and then a voltage of opposite polarity to the voltage applied at the first electrode is applied between the second electrode and the photoconductor, and the charged toner adhered to the non-exposure portion is electrostatically removed (a second development step).

Next, the trapped charges of the image formation processes of the related arts described above will be discussed with reference to FIG. 2. In FIG. 2, the horizontal axis shows surface potential (toner voltage Vt) of a toner layer corresponding to an exposure portion after the first development step of the previously described related arts, and the vertical axis shows surface potential of the photoconductor (trapped voltage Vₛ) immediately after the charged toner has been blown away with nitrogen gas.

In FIG. 2, the triangles 21A, 21B, 21C, etc. show measurements of relationships between toner voltage and trapped voltage in a case of employing a photoconductor in which a transparent conductive layer and a photoconductive layerphotoconductive layer are layered onto a transparent substrate in the related art described above. A solid line 22 is a theoretical line calculated by assuming that a trapped charge corresponding to a charge quantity of charged toner is distributed at the surface of the photoconductive layerphotoconductive layer. A curve 23, which is a broken line, is a theoretical line found by assuming that the trapped charge corresponding to the charge quantity of charged toner is uniformly distributed in a direction of thickness of the photoconductive layerphotoconductive layer.

In FIG. 2, the curve 23 closely matches the measurement values 21A, 21B, 21C, etc. Thus, it can be considered that, after the charged toner layer has been removed, the trapped charge is uniformly distributed within the photoconductive layerphotoconductive layer. This corresponds to, after the optical irradiation, an apparent doubling of capacitance of the photoconductor after irradiation has stopped, which means that, in order to obtain a printout with a density of at least a certain value, it is necessary to raise a development bias voltage to at least twice that in a case in which trapped charge is distributed at the surface of the photoconductive layerphotoconductive layer.

In contrast, in the other related art, a photoconductive layerphotoconductive layer of a photoconductor at which copper foil is adhered to the surface of the photoconductive layer is employed. Results of measuring the trapped voltages immediately after blowing off a toner layer that has been developed and adhered on the copper foil are shown. These measurement values are indicated by the circles 24A, 24B, etc. in FIG. 2. In FIG. 2, the circles 24A, 24B, etc. closely match the curve 22. Thus, for a case in which the copper foil is provided (i.e., a case in which a dot-form conduction layer covers the photoconductive layer formed at the photoconductor that is employed), it can be seen that the trapped charges are formed at the surface of the photoconductive layer. Therefore, providing trapped charge sites at the surface of a photoconductive layer is effective for increasing contrast.

However, there is a problem in that, even with the related art described above, contrast is a little lower than with the conventional Carlson method. Below, this problem will be discussed with reference to results when an analysis of latent image charge amounts at photoconductor surfaces is applied.

First, a latent image charge amount Q_{D} in a case in which trapped charge sites are structured at the photoconductor surface will be considered. Assuming development with a developing bias voltage V_{b} in a first development step, and that a surface potential of a toner layer due to the adherence of charged toner is a potential V_{b} the same as the developing bias, the following equation is obtained.

$${V}_{b} = \frac{{ρ}_{t}}{2 {ɛ}_{0} {ɛ}_{t}} {x}^{2} \qquad ( 1 )$$

Here, ε₀ is permittivity of a vacuum, εₜ is relative permittivity of the charged toner layer, ρₜ is electrostatic charge density of the charged toner layer, and x is thickness of the charged toner layer.

Further, because the latent image charge amount Q_{D} is a sum of developed charges, Q_{D} can be represented by the following equation.
Q_{D}=ρ₁x (2)

If the toner layer thickness x is found by equation (1) and substituted into equation (2), the latent image charge Q_{D} meets the following equation.
Q_{D}=\sqrt{2ε₀εₜρₜV_{b}} (3)

In contrast, a latent image charge Qₖ in the usual Carlson method is represented by the following equation.

$${Q}_{K} = {( \frac{{ɛ}_{0} {ɛ}_{p}}{L} V )}_{SC} \qquad ( 4 )$$

Here, εₚ is relative permittivity of a photoconductor, L is thickness of the photoconductor, and V_{sc} is surface potential of the photoconductor.

Taking an ordinary organic photoconductor as an example, thickness of the photoconductor=20 μg/m and relative permittivity εₚ of the photoconductor=3.0. Further, relative permittivity of a toner layer εₜ=2.2 and charge density of charged toner ρₜ=6.6 C/m³ (corresponding to a relative toner charge of 10 μC/g). Hence, results of calculation of the latent image charges Q_{D} and Qₖ are as shown in FIG. 3. The vertical axis shows latent image charge amount, and the horizontal axis shows toner layer voltage and surface potential of the photoconductor. Theoretical values of Q_{D} from equation (3) and theoretical values of Q_{K} from equation (4) are shown.

As is clear from FIG. 3, the latent image charge amount is greater with the usual Carlson method for toner layer surface voltages of 200 V and above. It can also be seen, from equation (3), that the latent image charge increases as the electrostatic charge density of the toner rises. However, in general, image density decreases when relative toner charge increases. Thus, it can be seen that, in ordinary usage conditions, the latent image charge amount of the Carlson method is larger, and even the image formation process of the related art described above still features insufficient contrast.

### SUMMARY OF THE INVENTION

The present invention has been made in view of the above circumstances and provides an image formation device and image formation process.

According to an embodiment of the present invention, an image formation device includes: a charge conservation member, which includes a transparent conductive substrate, a photoconductive layer formed on the transparent conductive substrate, and microscopic isolated island-form charge sites, at which numerous microelectrodes which are capable of charge conservation are formed on the photoconductive layer to be distributed more finely than individual pixels; a conductive voltage supply member, which touches the microscopic isolated island-form charge sites; a power source for latent image formation which, in a state in which the voltage supply member touches the microscopic isolated island/orm charge sites, applies voltage between the transparent conductive substrate and the voltage supply member, for forming an electric field in the charge conservation member; and an exposure section which, in a state in which the electric field is formed in the charge conservation member, performs image exposure, in accordance with an image pattern, from the transparent conductive substrate side of the charge conservation member, for forming an electrostatic latent image at the microscopic isolated island-form charge sites.

### BRIEF DESCRIPTION OF THE DRAWINGS

Embodiments of the present invention will be described in detail based on the following figures, wherein:

FIGS. 1A and 1B are schematic explanatory diagrams of a conventional image formation process;

FIG. 2 is a comparative explanatory chart of experimental results and theoretical values for distributions of trapped charges;

FIG. 3 is a graph showing a comparison of latent image charges Qₖ of the Carlson method with latent image charges Q_{D} in a case of a toner development method of a conventional technology;

FIGS. 4A and 4B are schematic explanatory diagrams of a latent image formation process of a first embodiment of the present invention;

FIG. 5A is a schematic explanatory chart describing characteristics of latent image charge, which is a condition to be specified in the latent image formation process of the first embodiment of the present invention;

FIG. 5B is a schematic explanatory chart describing characteristics of applied voltage, which is a condition to be specified in the latent image formation process of the first embodiment of the present invention;

FIG. 5C is a schematic explanatory chart describing variations in surface potential of a photoconductor caused by a negative latent image, which is a condition to be specified in the latent image formation process of the first embodiment of the present invention;

FIG. 6 is a sectional view showing general structure of a color laser printer relating to the first embodiment of the present invention;

FIG. 7A is a diagram showing a portion of a photoconductive drum of the first embodiment of the present invention, and is a partial sectional view schematically showing a portion of a cross section which is cut perpendicular to an axial direction;

FIG. 7B is a diagram showing the portion of the photoconductive drum of the first embodiment of the present invention, and is a partial plan view schematically showing an arrangement of microscopic isolated island-form electrodes;

FIG. 8 is a sectional view showing general structure of a printing section of the first embodiment of the present invention;

FIGS. 9A and 9B are views for explaining a principle of a latent image formation process of a second embodiment of the present invention;

FIGS. 10A and 10B are schematic explanatory views of the latent image formation process of the second embodiment of the present invention;

FIG. 11 is a sectional view showing general structure of a color laser printer relating to the second embodiment of the present invention;

FIG. 12 is a sectional view showing general structure of a printing section of the second embodiment of the present invention; and

FIG. 13 is a sectional view showing general structure of a printing section of a mode of Example 2-3 of the present invention.

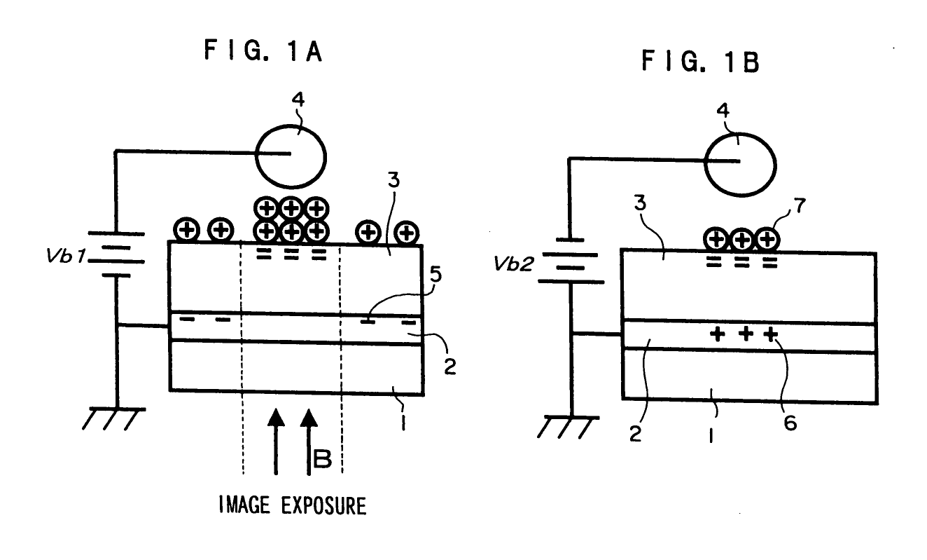

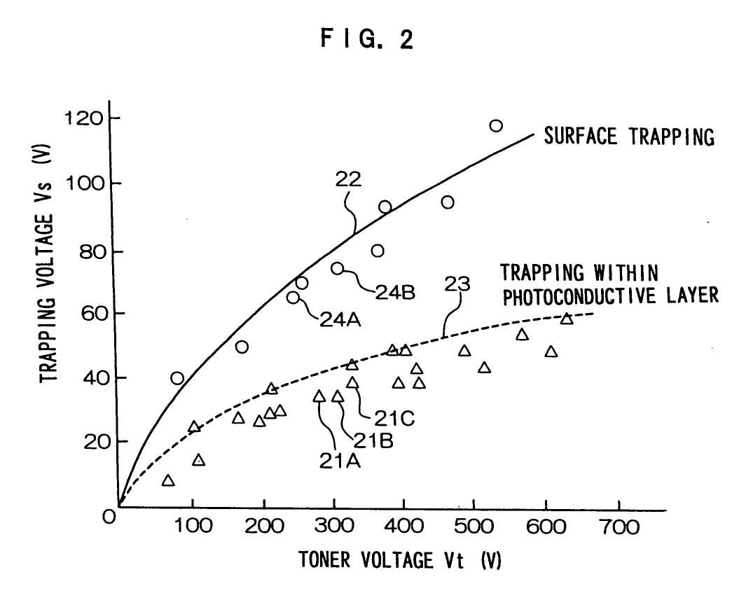

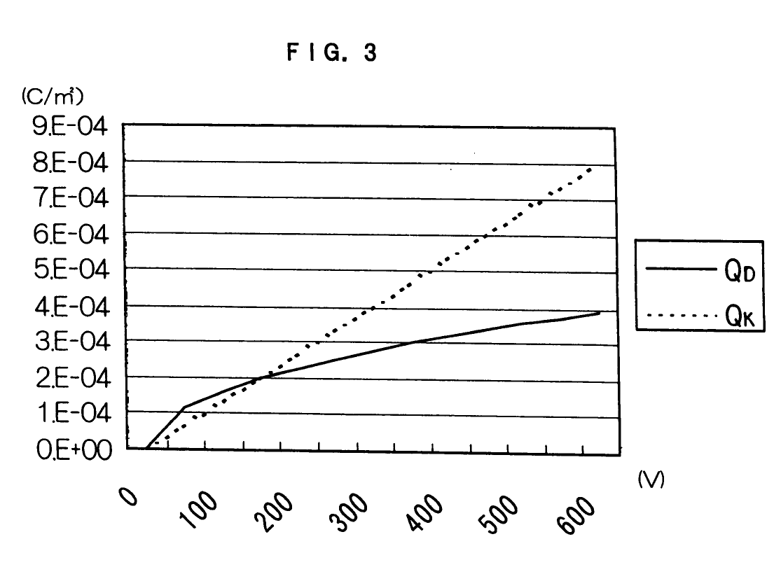

### DETAILED DESCRIPTION OF THE INVENTION

Herebelow, embodiments of the present invention will be described in detail with reference to the drawings.

### FIRST EMBODIMENT

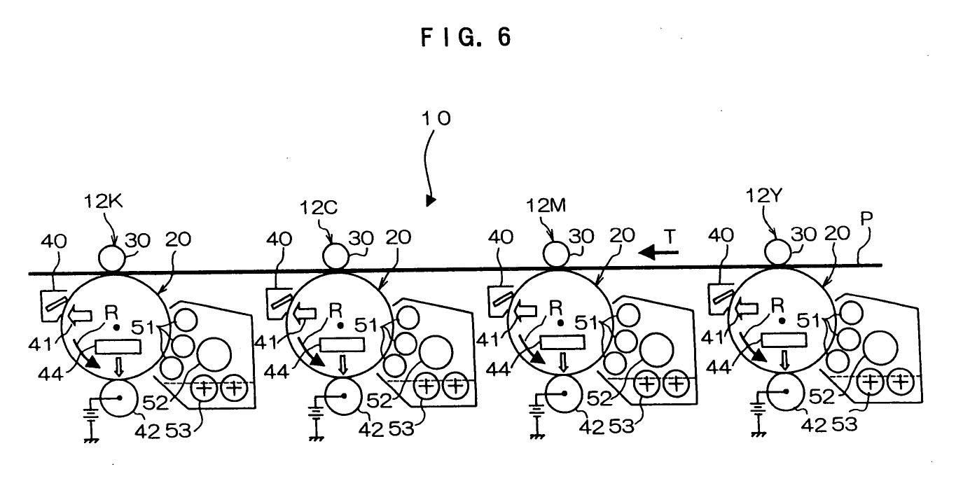

As shown in FIG. 6, a color laser printer (hereafter referred to simply as a printer) which serves as an image formation device of a first embodiment is structured with printing sections 12Y, 12M, 12C and 12K (hereafter referred to as “printing sections 12Y to 12K”) arranged in this order from upstream to downstream along a conveyance direction (the direction of arrow T). The printing sections 12Y to 12K transfer respective toner images of the colors yellow (Y), magenta (M), cyan (C) and black (K) to continuous paper P, which serves as an object of transfer, superposing the toner images of the respective colors to form an image.

At a conveyance direction upstream side of the printing sections 12Y to 12K, a paper conveyance section (which is not illustrated) is provided. Meanwhile, a fixing section (not shown) and an ejection section (not shown) are provided at a conveyance direction downstream side of the printing sections 12Y to 12K. The fixing section fixes unfixed toner images that have been sequentially transferred to the continuous paper P by the printing sections 12Y to 12K, and the ejection section ejects the continuous paper.

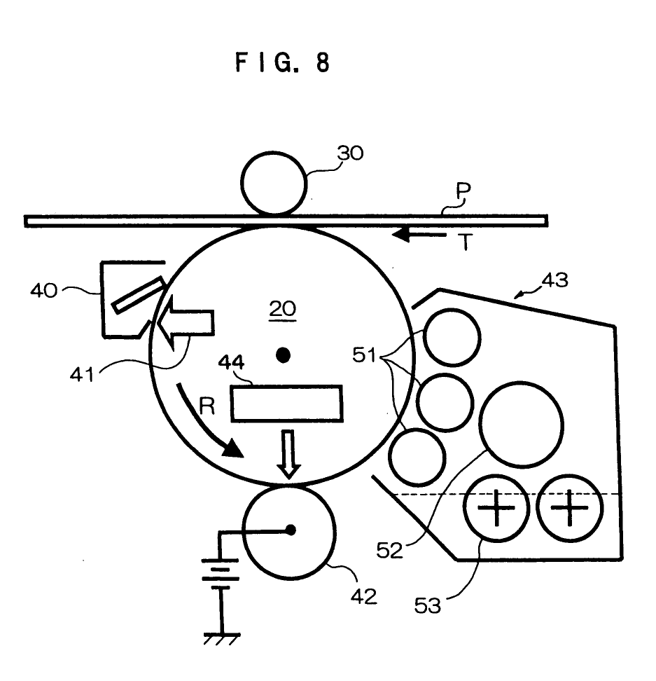

At each of the printing sections 12Y to 12K, a photoconductive drum 20 is provided, as shown in FIG. 8. The photoconductive drum 20 serves as a charge conservation member, which functions as an image-bearing body at which the toner image is formed. An organic photoconductor for heavy-duty printing, which can be charged by a positive electrode, can be used at the photoconductive drum 20.

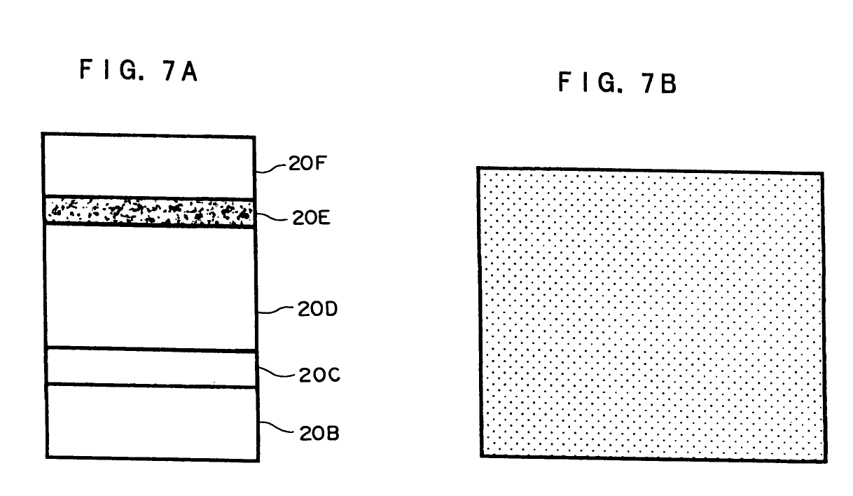

As shown in FIG. 7A, the photoconductive drum 20 is structured by a drum with a five-layer structure. A circular tube-form transparent glass pipe 20B serves as a transparent substrate. A transparent conductive layer 20C, a photoconductive layer 20D and microscopic isolated island-form electrodes 20E are laminated in this order on an outer peripheral face of the transparent glass pipe 20B. Further, an insulation layer 20F is laminated on the microscopic isolated island-form electrodes 20E. The transparent conductive layer 20C serves as a transparent conductive substrate. The photoconductive layer 20D serves as a photoconductive layer. The microscopic isolated island-form electrodes 20E form microscopic isolated island-form charge sites, which are formed by microelectrodes, which are capable of charge conservation, being distributed more finely than individual pixels.

As shown in FIG. 7B, the microscopic isolated island-form electrodes 20E are structured by the numerous microelectrodes capable of charge compensation being distributed in the form of a layer, more tightly than individual pixels, so as to not make contact with one another. The photoconductive layer 20D is coated to a predetermined thickness by a coating process or the like, and then the microscopic isolated island-form electrodes 20E are structured, in a pattern which is finer than a pixel density due to a mask deposition process or the like, by sputtering an electrode metal such as copper or the like. Thus, an electrode layer is formed with a structure in which numerous extremely fine isolated dot-form electrodes are closely arranged with predetermined dot spacings. A density of the microscopic isolated island-form electrodes 20E can be set in accordance with a resolution of images, and resolution can be raised subject to raising the density of the electrodes.

As shown in FIG. 8, a transfer roller 30, a cleaner 40, an optical static-elimination lamp 41, a conductive rubber roller 42, an image exposure device 44 and a developing apparatus 43 are arranged around the photoconductive drum 20 in this order along a direction of rotation of the photoconductive drum (the direction of arrow R). At least one row of LEDs is arranged at the image exposure device 44, in which numerous LEDs are arranged in row(s) along a length direction of the photoconductive drum.

At the developing apparatus 43, a two-component magnetic brush developing apparatus is employed. In this developing apparatus, plural developing rollers 51, a magnetic roller for stirring 52 and two agitation screws 53 are provided. As a developing agent, it is possible to use, for example, a developing agent in which an insulative toner with a particle diameter of around 5 μm and a carrier, such as a conductive iron powder; with a particle diameter of around 60 μm are mixed. In the developing apparatus, agitation of the developing agent and frictional charging of the toner are implemented by the two agitation screws 53. The developing agent which has been agitated by these two agitation screws 53 is conveyed to the set of developing rollers 51 by the magnetic roller for stirring 52. A peripheral speed of the developing rollers 51 may be, for example, 1.1 times a process speed.

In the first embodiment, in a first developing process (a first step), rather than employing a charged toner as is conventional, the conductive rubber roller 42 is caused to touch the insulation layer 20F with a predetermined pressure, a power source for latent image formation is used to form an electric field between the conductive rubber roller 42 and the transparent conductive layer 20C, and an electric field is formed at the microscopic isolated island-form electrodes 20E, which are proximate electrodes. In the state in which the electric field is formed, the LEDs of the image exposure device 44, which is provided inside the transparent glass pipe 20B, are illuminated in accordance with an image pattern to perform image exposure, and an electrostatic latent image is formed at the microscopic isolated island-form electrodes 20E. In this manner, an electrostatic latent image featuring trapped charges of sufficient magnitude is formed at the microscopic isolated island-form electrodes 20E.

Thereafter, in a second developing process (second step), the developing apparatus 43 is used to develop the latent image with the developing agent, and an image is formed. According to the first embodiment, because the microscopic isolated island-form electrodes 20E are covered with the insulation layer 20F, a problem of, when the voltage is applied and the electric field is formed in the first step, charge-tapping sites being charged by the applied voltage even where there is no image exposure is avoided. Furthermore, because the insulation layer of the present embodiment is structured at the photoconductive layer, a static-elimination effect of the optical static-elimination lamp 41 operates effectively, charge that has accumulated at the surface of the insulation layer is thoroughly removed, and it is possible for the photoconductive drum to withstand repeated re-use.

Herein, if a likelihood of the charge-trapping sites being charged by the applied voltage is small, the insulation layer 20P may be omitted.

In the first embodiment, if the insulation layer 20F is structured with the same material as the photoconductive layer 20D, it is possible to efficiently remove charge—which is generated in the latent image formation process, the image-developing process and a transfer process—that has adhered at the surface of the insulation layer 20F with the optical static-elimination lamp 41, and it is possible to set charge of the insulation layer surface to substantially zero. Of course, it is also possible to form this insulation layer as a photoconductive layer which has sensitivity to a wavelength different from the image exposure light source. In such a case, because there is no photosensitivity thereat in the latent image formation process of the first step, the layer is in practical terms an insulator. Then, at an optical static-elimination section, the insulation layer can be activated by a static-elimination light, to implement a thorough static-elimination effect.

It is further possible to provide an additional photoconductive layer on the insulation layer, and to utilize this photoconductive layer for performing static removal.

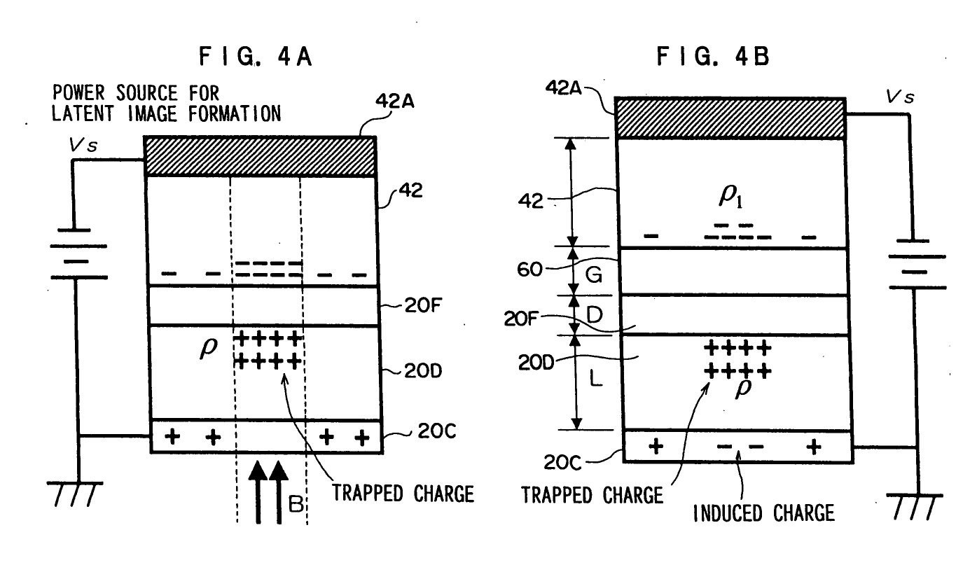

Now, magnitude of an applied voltage of the first embodiment will be investigated. FIG. 4A illustrates a model of a state in which an applied voltage Vₛ is applied between the conductive rubber roller 42 and the transparent conductive layer 20C, by a negative terminal of a power source for latent image formation being connected to a conductive substrate 42A of the conductive rubber roller 42 and a positive terminal of the latent image formation power source being connected to the transparent conductive layer 20C, and exposure is performed. FIG. 4B illustrates a model of a state in which, when contact between the conductive rubber roller 42 and the insulation layer 20F has been released, a gap 60 is formed between the conductive rubber roller 42 and the insulation layer 20F.

In the first step, when image exposure is performed from the inner side of the glass pipe via the transparent conductive layer 20C, as shown in FIG. 4A, photocarriers are generated in the photoconductive layer 20D and positive charges, in the illustrated case, migrate to the microscopic isolated island-form electrodes 20E, which constitute a charge-tapping layer. A surface charge density ρ of charge which is accumulated at the charge-trapping layer at this time is represented by the following equation.

$$ρ = - \frac{{ɛ}_{0} {ɛ}_{d} {V}_{S}}{D} \qquad ( 5 )$$

Here, ε₀ is permittivity of a vacuum, ε_{d} is relative permittivity of the insulation layer, D is thickness of the insulation layer, and Vₛ is the applied voltage.

In the subsequent second step, when light illumination has stopped, as shown in FIG. 4B, the charge density shown by equation (5) is maintained unaltered at the charge-trapping layer, and the photoconductive layer returns to the insulative condition. In this state, the conductive rubber roller 42, which is a voltage supply member, which has been touching the surface of the insulation layer 20F is gradually separated, and a gap distance G of the gap 60 becomes larger. At this time, the following relationships apply.

$$\begin{matrix}- ( \frac{{ρ}_{0}}{{ɛ}_{0} {ɛ}_{p}} L + \frac{{ρ}_{0} + ρ}{{ɛ}_{0} {ɛ}_{d}} D + \frac{{ρ}_{0} + ρ}{{ɛ}_{0}} G ) = {V}_{S} & ( 6 ) \\ {ρ}_{0} + ρ + {ρ}_{1} = 0 & ( 7 )\end{matrix}$$

Here, surface charge density ρ₀ is induced at the transparent conductive layer. If ρ₀ is to be found from equation (6), the following equation is obtained.

$${ρ}_{0} = - \frac{{V}_{S} + \frac{ρ}{{ɛ}_{0}} \cdot \frac{D}{{ɛ}_{d}} + \frac{ρ}{{ɛ}_{0}} G}{( \frac{L}{{ɛ}_{p}} + \frac{D}{{ɛ}_{d}} + G )} {ɛ}_{0} \qquad ( 8 )$$

If the surface charge density ρ of the latent image from equation (5) is substituted in equation (8), the following equation is obtained.

$${ρ}_{0} = \frac{G \cdot \frac{{ɛ}_{d}}{D} {V}_{S} {ɛ}_{0}}{( \frac{L}{{ɛ}_{p}} + \frac{D}{{ɛ}_{d}} + G )} \qquad ( 9 )$$

Here, L/εₚ represents equivalent thickness of the photoconductive layer, and D/ε_{d} represents equivalent thickness of the insulation layer.

Immediately after the first step, there is a state in which the gap distance G is zero. Hence, if G=0 is substituted into equation (9), ρ₀=0, and there is no charge induced on the transparent conductive layer. Thus, from equation (7), it can be seen that all of the induced charge is induced at the conductive substrate 42A of the voltage supply member.

Subsequently, as the gap distance G gradually becomes larger in the second step, as is shown by equation (9), charge induced at the microscopic isolated island-form electrodes gradually increases and, finally, a charge with the same charge density as in equation (5) but the opposite polarity is induced. Meanwhile, the charge induced at the conductive substrate 42A of the voltage supply member gradually becomes smaller, and finally reaches zero.

An important consideration for this second step is to determine conditions in which air breakdowns will not be caused by the gradually increasing gap distance. Accordingly, if equation (1) is substituted into equation (6), the following equation applies for calculating a gap voltage V_{g}.

$${V}_{G} = \frac{( 1 + \frac{L}{{ɛ}_{p}} \cdot \frac{{ɛ}_{d}}{D} ) G}{( G + \frac{L}{{ɛ}_{p}} + \frac{D}{{ɛ}_{d}} )} {V}_{S} \qquad ( 10 )$$

Provided this gap voltage is not more than a air breakdown voltage V_{gth} of the following equation, which is generally well known, an electrostatic latent image (i.e., a negative latent image) that is formed by the trapped charges will not be damaged by air breakdowns.
V_{gth}=312+6.2×10⁶ G (11)

Thus, by applying the condition V_{g}<V_{gth}, the following equation is obtained.

$$\frac{( 1 + \frac{L}{{ɛ}_{p}} \cdot \frac{{ɛ}_{d}}{D} ) {GV}_{s}}{G + \frac{L}{{ɛ}_{p}} + \frac{D}{{ɛ}_{d}}} < 312 + 6.2 \times {10}^{6} G \qquad ( 12 )$$

If equation (12) is rearranged, the following equation is obtained.

$$6.2 \times {10}^{6} {G}^{2} + G \{ 312 + 6.2 \times {10}^{6} ( \frac{L}{{ɛ}_{p}} + \frac{D}{{ɛ}_{d}} ) - ( 1 + \frac{L}{{ɛ}_{p}} \cdot \frac{{ɛ}_{d}}{D} ) {V}_{s} \} + 312 ( \frac{L}{{ɛ}_{p}} + \frac{D}{{ɛ}_{d}} ) > 0 \qquad ( 13 )$$

Equation (13) is a quadratic equation referring to the gap distance G. Therefore, when this conditional expression is negative, air breakdowns will not occur. To find a maximum applicable voltage V_{smaxab} provided by this conditional expression, the following equation applies.

$${V}_{s max ab} = \frac{312 + 6.2 \times {10}^{6} ( \frac{L}{{ɛ}_{p}} + \frac{D}{{ɛ}_{d}} ) + \sqrt{4 \times 6.2 \times {10}^{6} \times 312 ( \frac{L}{{ɛ}_{p}} + \frac{D}{{ɛ}_{d}} )}}{( 1 + \frac{L}{{ɛ}_{p}} \cdot \frac{{ɛ}_{d}}{D} )} \qquad ( 14 )$$

Equation (14) gives the maximum applicable voltage, which is found by representing the air breakdown voltage as a function of the gap distance with equation (11). Accordingly, in order to avoid air breakdowns, it is sufficient for the applied voltage Vₛ to be less than the maximum applicable voltage V_{smaxab}.

Ordinarily, for any gap, in order for there to be no air breakdowns, it is considered sufficient for a minimum gap voltage to be 312 V. Such a condition is reliable and safe. If investigations are advanced herebelow with this condition, the applied voltage Vₛ meets the following equations.

$${V}_{S} < \frac{312 ( G + \frac{L}{{ɛ}_{p}} + \frac{D}{{ɛ}_{d}} )}{( 1 + \frac{L}{{ɛ}_{p}} \cdot \frac{{ɛ}_{d}}{D} ) G} \qquad ( 15 )$$

Here, if G equals to infinite, i.e., in a final state, the Vₛₘₐₓ is obtained as below.

$${V}_{s max} = \frac{312}{1 + \frac{L}{{ɛ}_{p}} \cdot \frac{{ɛ}_{d}}{D}} \qquad ( 16 )$$

Further, a maximum latent image charge density ρₘₐₓ, which is obtained when a maximum applied voltage Vₛₘₐₓ is applied, is given by the following equation, in which equation (16) is substituted into equation (5).

$${ρ}_{max} = \frac{312 {ɛ}_{0}}{\frac{D}{{ɛ}_{d}} + \frac{L}{{ɛ}_{p}}} \qquad ( 17 )$$

Further still, if a lower limit of the latent image charge density, which is necessary when toner image formation is to be performed, is ρₘᵢₙ, a minimum applied voltage Vₛₘᵢₙ for such a case is given by the following equation.

$${V}_{S min} = \frac{{ρ}_{min}}{{ɛ}_{0} {ɛ}_{d}} D \qquad ( 18 )$$

Thus, a range of applied voltages Vₛ which are capable of providing latent image charge amounts that are necessary and sufficient for when toner image formation is carried out is represented by the following equation.

$$\frac{{ρ}_{min}}{{ɛ}_{0} {ɛ}_{d}} D < {V}_{S} < \frac{312}{1 + \frac{L}{{ɛ}_{p}} \cdot \frac{{ɛ}_{d}}{D}} \qquad ( 19 )$$

A latent image charge amount (surface charge density) ρ at such times is given by the following equation.

$${ρ}_{min} < ρ < \frac{312 {ɛ}_{0}}{\frac{D}{{ɛ}_{d}} + \frac{L}{{ɛ}_{p}}} \qquad ( 20 )$$

A photoconductor surface potential Vₛᵢ due to the negative latent image at a moment at which the second step finishes can be found by dividing the negative latent image charge amount ρ of equation (20) by electrostatic capacity of the photoconductor, giving the following equation.

$$\frac{{ρ}_{min}}{{ɛ}_{0} {ɛ}_{p}} L < {V}_{si} < \frac{312}{1 + \frac{D}{{ɛ}_{d}} \cdot \frac{{ɛ}_{p}}{L}} \qquad ( 21 )$$

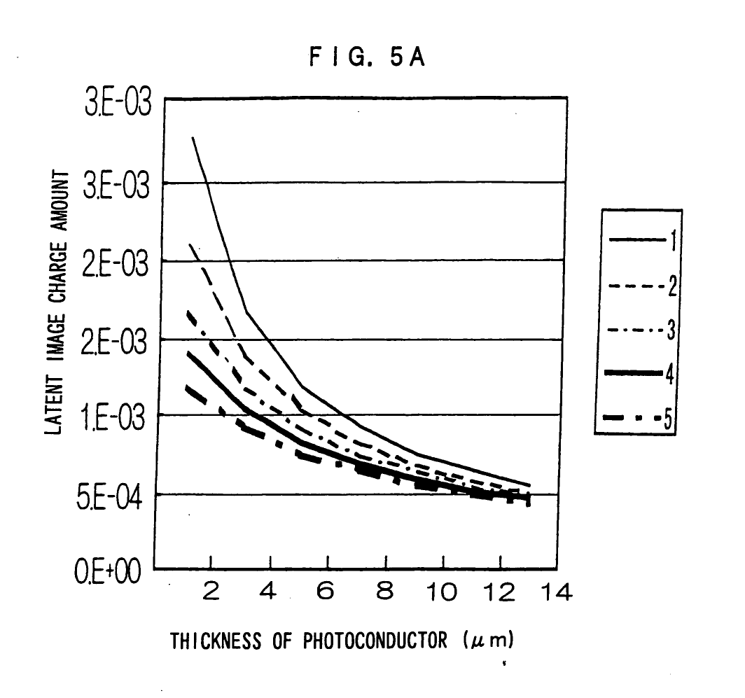

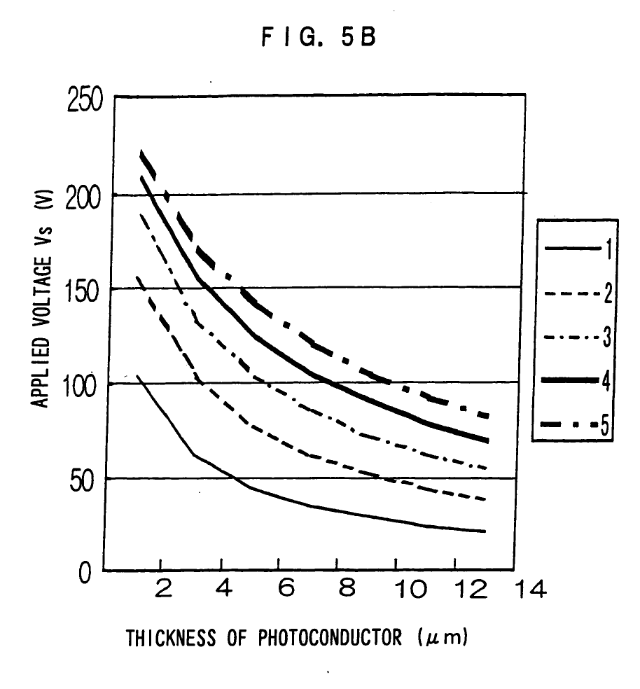

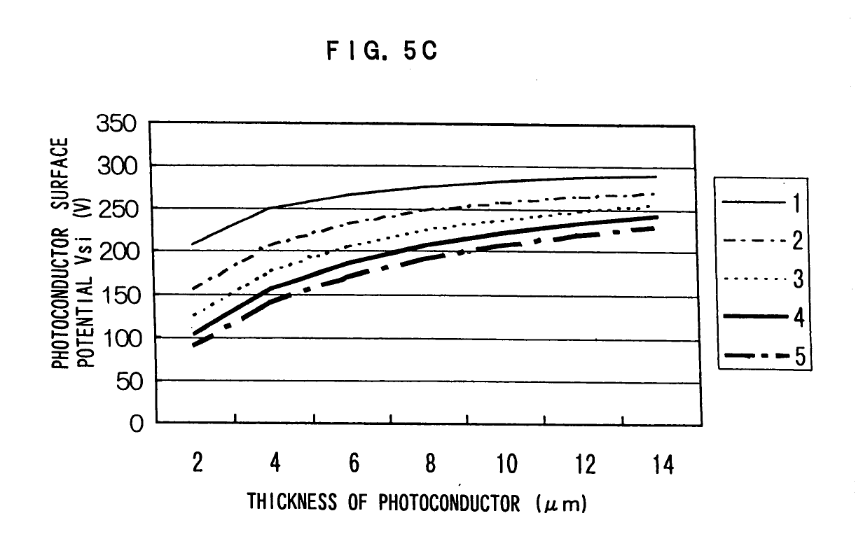

Now, using equations (19), (20) and (21), quantitatively evaluated results for the latent image formation process of the first embodiment are shown in FIGS. 5A to 5C. FIG. 5A shows latent image charge amounts ρ, FIG. 5B shows applied voltages Vₛ, and FIG. 5 C shows photoconductive drum surface potentials Vₛᵢ that are obtained. The horizontal axes show thickness L of the photoconductive drum (μm), and the parameter is thickness D of the insulation layer (μm). That is, the parameters ‘1’, ‘2’, ‘3’, ‘4’ and ‘5’ represent, respectively, 1 μm, 2 μm, 3 μm, 4 μm and 5 μm. It is assumed that relative permittivities of the photoconductive drum and the insulation layer are both 3.0. From FIG. 5A, it can be seen that, in order to increase latent image charges, it is better to make the thickness of the photoconductive drum thinner and also to make the thickness of the insulation layer thinner. Further, from FIG. 5B, it can be seen that, in order to raise the applied voltage to some extent within the range in which air breakdowns will not occur, it is better to make the photoconductive drum thickness thinner but to make the insulation layer thickness thicker. Further yet, FIG. 5C shows that, in order to make the photoconductive layer surface potential that is formed at the negative latent image larger, it is necessary for the photoconductive drum thickness to be in a certain range and it is necessary to make the insulation layer thickness thinner.

Incidentally, regarding a latent image charge that is required for a usual electrophotographic process, in a case with an organic photoconductor, a photoconductive drum thickness L=20 μm, relative permittivity εₚ=3.0 and an electrostatic potential of the photoconductive drum is approximately 600 V. Therefore, the latent image charge amount is 796 μC/m², which is to say, approximately 800 μC/m² (8×10⁻⁴ C/m²). If conditions capable of achieving such a value are found from FIGS. 5A to 5C and, as an example, thickness of a photoconductive drum is 4 μm and thickness of an insulation layer is 1 μm, a photoconductive drum surface potential of 250 V will be obtained with an applied voltage of about 60 V. V_{smaxab}, if calculated from equation (14), is 87 V, in which case the photoconductive drum surface potential will be 348 V, so it is possible to increase the surface potential by around 40%.

In the embodiment described above, an example which employs a conductive rubber roller as the voltage supply member has been described. However, it is also possible to employ a voltage supply member which is structured with a conductive magnetic powder.

### SECOND EMBODIMENT

Now, a second embodiment of the present invention will be described. For this second embodiment, structural portions that are the same as in the first embodiment are assigned the same reference numerals, and descriptions of these structures will be omitted.

Features of the second embodiment are that a power source for separation discharge prevention is provided, separately from the power source which applies the latent image formation voltage, and applies a voltage for separation discharge prevention, and that the separation discharge prevention voltage is applied in the second step in addition to the application of the latent image formation voltage.

First, a principle of operation of the second embodiment will be described.

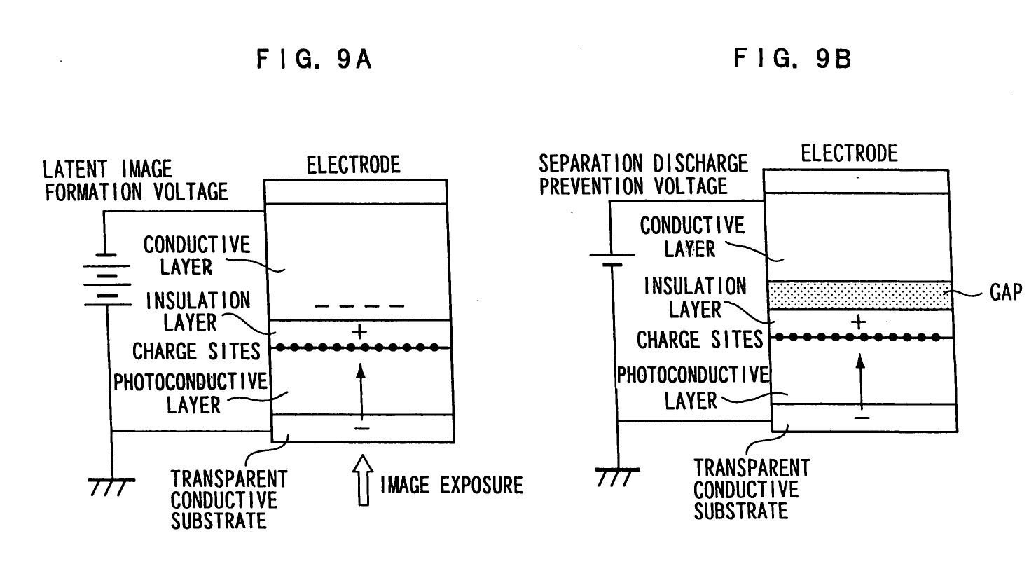

As shown in FIG. 9A, when the latent image formation voltage is applied to the charge conservation member via the voltage supply section, which is a conductive layer, positive charge is induced in the transparent conductive substrate. In this state, when image exposure is performed, charge at an exposed portion migrates toward the charge sites and, finally, positive charges corresponding to an image pattern are retained at the charge sites, as a negative latent image. Because the photoconductor acts as an insulator after the exposure, the negative latent image remains at the charging sites. That is, the positive charge is stopped as shown in FIG. 9A. In addition, a charge of opposite polarity to this charge arises at the surface of the conductive layer as an induced charge.

Then, as shown in FIG. 9B, in a separation process, in order to facilitate induction of negative charge at the transparent electrode side in accordance with the positive charge of the latent image charge, the separation discharge prevention voltage (i.e., a voltage lower than the latent image formation voltage or a voltage of opposite polarity to the latent image formation voltage) is applied to the conductive layer by a second conductive substrate 54A, which is connected to a positive terminal of a power source. Hence, as the charge conservation member and the conductive member are separating, negative charge is induced at the transparent electrode side in accordance with the positive charge of the latent image charge. Consequently, even when the gap is being formed between the charge conservation member and the conductive member, separation discharges will not occur at this gap, and the high-contrast latent image that has been formed by the latent image formation process is preserved.

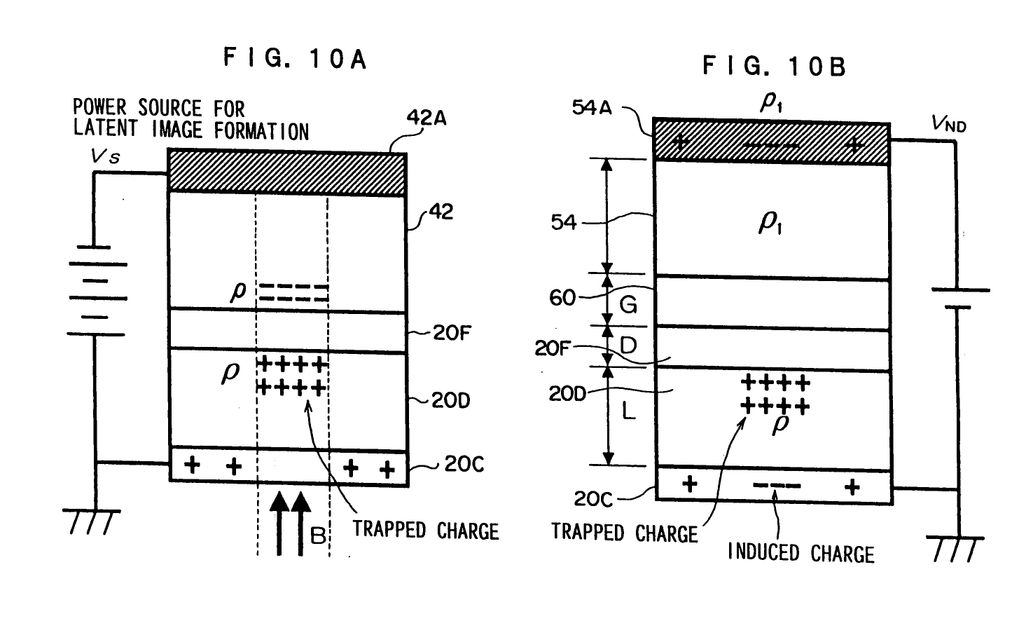

Herebelow, magnitude of an applied voltage for the second embodiment will be investigated. As shown in FIG. 10A, voltage is applied by the latent image formation power source between the voltage supply member and the charge conservation member, which is structured by the transparent conductive layer 20C, the photoconductive layer 20D and the insulation layer 20F. In this voltage application state, image exposure is performed from the transparent conductive layer 20C side. During this image exposure, photocarriers are generated in the photoconductive layer 20D, and are retained to serve as the latent image charge p at the microscopic isolated island/orm electrodes 20E at a boundary face of the insulation layer 20F. Meanwhile, a charge −ρ of opposite polarity is induced at the surface of the voltage supply member. Subsequent to exposure, this state is conserved.

As shown in FIG. 10B, while the voltage supply member is separating from the charge conservation member, the separation discharge prevention voltage (the voltage smaller than the latent image formation voltage or voltage of opposite polarity) is applied to the conductive substrate. In this state, separation gradually proceeds. Correspondingly, the charge of opposite polarity corresponding to the latent image charge (i.e., trapped charge) is gradually reduced at the voltage supply member, and a corresponding charge appears as an induced charge at the transparent conductive layer 20C side. Because the gap voltage is reduced to below the air breakdown voltage in this manner, the latent image charge formed in the first step will not be damaged by separation discharges, and will still be preserved after the process of separation.

In the process shown in FIG. 10A, the image exposure is performed from the rear side of the transparent glass pipe 20B, the photocarriers are generated in the photoconductor, and the positive charges migrate to the microscopic isolated island-form electrodes 20E as shown in FIG. 10A. A surface charge density ρ that is accumulated at the trapped charges at this time is given by equation (22).

$$ρ = - \frac{{ɛ}_{0} {ɛ}_{d} {V}_{S}}{D} \qquad ( 22 )$$

In the process shown in FIG. 10B, the light illumination ceases, with the charge density of equation (22) being conserved unaltered at the microscopic isolated island-form electrodes 20E, and the photoconductive layer returns to the insulating condition. In this state, a separation discharge prevention voltage V_{ND} is applied to the conductive substrate 42A. The voltage supply member gradually separates from the photoconductive layer and the gap 60 becomes wider. This state is represented by equation (23) and equation (24).

$$\begin{matrix}- ( \frac{{ρ}_{0}}{{ɛ}_{0} {ɛ}_{p}} L + \frac{{ρ}_{0} + ρ}{{ɛ}_{0} {ɛ}_{d}} D + \frac{{ρ}_{0} + ρ}{{ɛ}_{0}} G ) = {V}_{ND} & ( 23 ) \\ {ρ}_{0} + ρ + {ρ}_{1} = 0 & ( 24 )\end{matrix}$$

Here, ρ₀ is the surface charge density induced at the transparent conductive layer 20C, ρ₁ is the surface charge density induced at the voltage supply member, εₚ is relative permittivity of the photoconductive layer, L is thickness of the photoconductive layer, and G is the gap distance. If the charge ρ₀ induced at the conductive substrate 42A is found from equation (23), equation (25) applies.

$${ρ}_{0} = - \frac{{V}_{ND} + \frac{ρ}{{ɛ}_{0}} \cdot \frac{D}{{ɛ}_{d}} + \frac{ρ}{{ɛ}_{0}} G}{( \frac{L}{{ɛ}_{p}} + \frac{D}{{ɛ}_{d}} + G )} {ɛ}_{0} \qquad ( 25 )$$

If the latent image charge density ρ of equation (22) is substituted into equation (25), equation (26) applies.

$${ρ}_{0} = \frac{( {V}_{S} - {V}_{ND} ) + G \cdot \frac{{ɛ}_{d}}{D} {V}_{S}}{( \frac{L}{{ɛ}_{p}} + \frac{D}{{ɛ}_{d}} + G )} {ɛ}_{0} \qquad ( 26 )$$

If a gap voltage V_{G} in this separation process is found from equation (26) and equation (22), equation (27) applies.

$$\begin{matrix}{V}_{G} = - \frac{{ρ}_{0} + ρ}{{ɛ}_{0}} G \\ = \frac{\frac{{ɛ}_{d}}{D} \cdot \frac{L}{{ɛ}_{p}} \cdot {V}_{S} + {V}_{ND}}{( \frac{L}{{ɛ}_{p}} + \frac{D}{{ɛ}_{d}} + G )}\end{matrix} \qquad ( 27 )$$

As is clear from equation (27), the gap voltage V_{G} can be greatly reduced by the separation discharge prevention voltage being set smaller than the latent image formation voltage or being set to the opposite polarity from the latent image formation voltage.

Further, it is better that the gap voltage V_{G} of equation (27) is not more than a air breakdown voltage Vₜₕ. For this condition, it is sufficient to calculate with the condition |V_{G}|<Vₜₕ. Accordingly, it can be seen that it is satisfactory to apply a separation discharge prevention voltage V_{ND} as provided by equation (28).

$$- {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} < {V}_{ND} < {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} \qquad ( 28 )$$

An optimal separation discharge prevention voltage V_{ND} is represented by equation (29).

$${V}_{ND} = - \frac{{ɛ}_{d}}{D} \cdot \frac{L}{{ɛ}_{p}} {V}_{S} \qquad ( 29 )$$

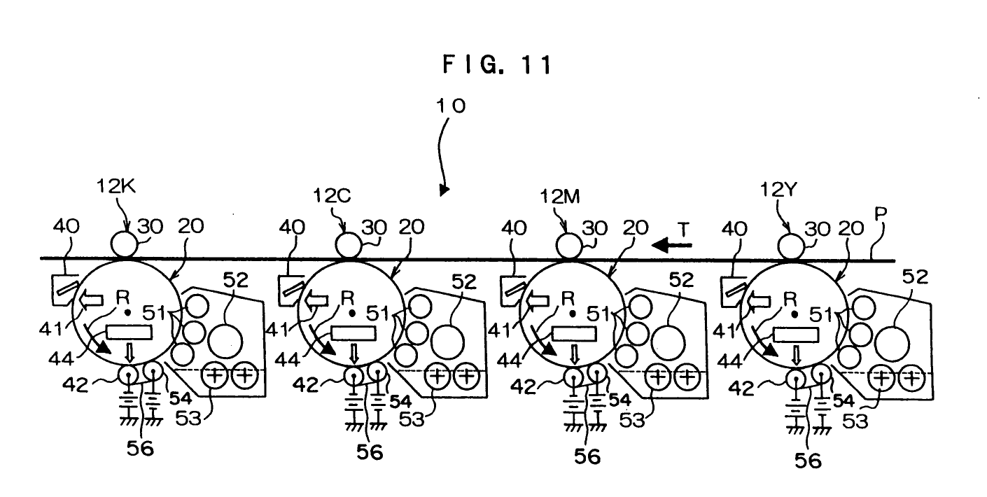

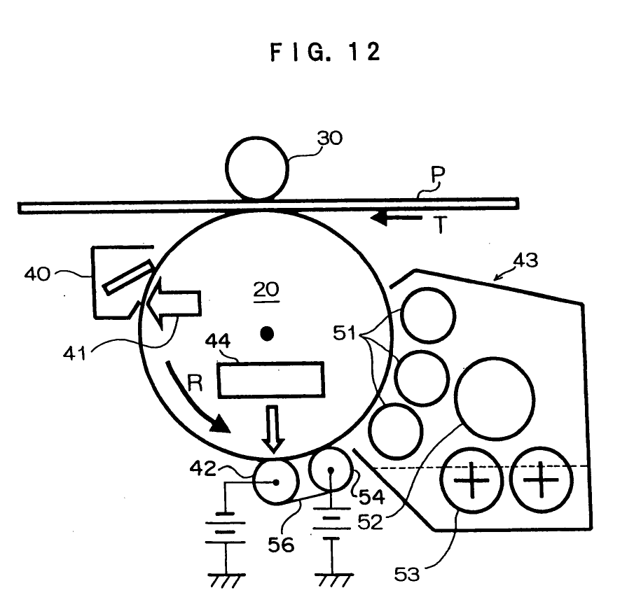

In order to apply the above-described separation discharge prevention voltage V_{ND}, in the second embodiment, as shown in FIGS. 11 and 12, a second conductive rubber roller 54 is provided in addition to the conductive rubber roller 42. The second conductive rubber roller 54 is equipped with the second conductive substrate 54A, which is connected to the positive terminal of a power source. In the second embodiment, a conductive belt 56 is formed at the conductive rubber roller 42 and the second conductive rubber roller 54 and presses against the photoconductive drum 20, and the respective rollers apply voltage therewith.

The application of the separation discharge prevention voltage to the photoconductive drum 20 by the second conductive rubber roller 54 is commenced from before the separation of the conductive rubber roller 42 from the photoconductive drum 20, and, when the conductive rubber roller 42 separates from the photoconductive drum 20, the second conductive rubber roller 54 is already in contact with the photoconductive drum 20.

Thus, in the second embodiment, after the electrostatic latent image has been formed at the microscopic isolated island-form charge sites, the voltage for separation discharge prevention is applied, and separation discharges while the conductive layer is separating from the photoconductor are prevented. Therefore, image formation subsequent to the formation of trapped charges of sufficient magnitude at the microscopic isolated island-form charge sites is possible, and a latent image contrast at least equal to the Carlson method can be obtained.

### EXAMPLES

### Example 1-1

First, an Example 1-1 of the first embodiment will be described. The photoconductive drum 20 of Example 1-1 is prepared by: applying 4 μm of a one-layer organic photoconductive layer by a coating method, to serve as the photoconductive layer; thereon, by a mask deposition method, sputtering copper in a pattern finer than a pixel density to structure a layer, of dots with a spacing of 2 μm and an isolated dot electrode diameter of 1 μm, to a thickness of 0.5 μm; and thereon, coating an insulative resin to 1 μm. Diameter of the photoconductive drum 20 is 240 mm. A process speed of Example 1-1, that is, a paper conveyance speed, is 1.0 m/s.

The conductive rubber roller 42 is structured by covering a core fixture which serves as a roller shaft with a resilient member. The resilient member has a single layer structure in which conductive carbon is dispersed, and a resistance value thereof is 10⁸ to 10⁹Ω. A roller diameter is a diameter of 30 mm (with a conventional corona charger, a circumference of around 20 cm is required), and hardness is about 30°. This conductive rubber roller is pressed against the photoconductive drum 20 with a total pressure of around 1 kgf.

As a developing agent, a developing agent in which an insulative toner with a particle diameter of around 5 μm is mixed with a carrier of conductive iron powder with a particle diameter of around 60 μm is employed. A peripheral speed of the developing rollers 51 is 1.1 times the process speed.

First, untransferred residual toner is removed from the photoconductive drum 20 by the cleaner 40, after which whole-surface exposure is performed by the optical static-elimination lamp 41, which is disposed at a rear face of the photoconductive drum 20, and surface potential of the photoconductive drum 20 (previous latent image charges) is reset to zero. Next, voltage is applied between the conductive rubber roller 42 and the photoconductive drum 20 by the latent image formation power source voltage Vₛ. In Example 1-1, 60 V is applied. At this time, utilizing the image exposure device 44 equipped with the LEDs, which are an image exposure section (with, for example, resolution 600 dpi and inter-dot spacing 42.5 μm), image exposure is performed in accordance with an image pattern. Accordingly, photocarriers are generated in the photoconductive layer 20D and, in Example 1-1, electrons migrate to the surface of the photoconductive layer, electrons are supplied to the charge-trapping sites, and latent image charge is formed. When, with rotation of the photoconductive drum 20, this latent image-charged region moves away from the conductive rubber roller, positive charge is gradually induced at the transparent substrate side in response to the negative latent image charge with negative polarity. Hence, at an image exposure portion, surface potential of the photoconductor forms a latent image potential which is a negative potential.

Incidentally, in Example 1-1, if a surface potentiometer is disposed between the conductive rubber roller 42 and the developing apparatus 43 and the latent image potential is measured, it can be confirmed that a potential of −250 volts is obtained, substantially the same as the theoretically determined value.

Thereafter, with a developing bias of the developing apparatus 43 set to 0 V, this negative latent image is developed. Accordingly, positively charged toner is adhered to the negative latent image portion (not shown), and an excellent toner image is provided. Further, it is confirmed that a surface potential of a toner layer after development is substantially zero. Thereafter, a voltage of −600 V is applied to the transfer roller 30, and the toner image is electrostatically transferred to paper. This is fixed at a fixing section (not shown) and printing is done.

In this manner, according to the present Example, excellent printouts which are free of fogging are obtained, and a process of charging the photoconductor which would be required as a prior stage in a conventional electrophotography process can be omitted. Therefore, there is no need to reserve space for disposing an ozone filter associated with a corona charger, and a charging apparatus and the like, and it is possible to reduce size of the device. With regard to printing density in Example 1-1, an excellent image with OD=1.5 or more and a fogging density of OD=0.02 or less is obtained.

Moreover, because the dot-form conduction layer is formed on the photoconductive layer by the microscopic isolated island-form electrodes, high electric fields are formed with regard to peripheral edge portions of the dot-form electrodes. Therefore, “edge effects” operate effectively, and a “print hollowing” phenomenon relating to solid blacks, in which density is slighter at a central portion of a printout, does not arise. Thus, there is a benefit in that dense, vivid printouts can be formed.

### Example 1-2

Next, an Example 1-2, in which the photoconductive layer of the photoconductive drum 20 is structured at an a-Si photoconductor, will be described. In this Example, indium oxide is vapor-deposited onto the transparent glass pipe 20B to form the transparent conductive layer 20C, and an a-Si film is formed on the transparent conductive layer 20C by vapor phase epitaxy to form the photoconductive layer 20D to 16 μm. Because relative permittivity of an a-Si photoconductor is four times that of an organic photoconductor, a film thickness of the photoconductive layer 20D is set to make an equivalent thickness the same. Thereafter, the microscopic isolated island-form electrodes 20E and the insulation layer are formed to 1 μm in the same manner as in Example 1-1. Using this photoconductive drum 20, the same tests are performed as in Example 1-1, and the same results are obtained.

### Example 1-3

For Example 1-3, instead of the conductive rubber roller 42, a developer constituted with only a conductive carrier with a particle diameter of around 60 μm is provided, and the same tests are performed as in Example 1-1. In such a case too, the same effects as with Example 1-1 can be obtained.

### Example 2-1

Next, an Example 2-1 of the second embodiment will be described.

As shown in FIGS. 11 and 12, the transfer roller 30, the cleaner 40, the optical static-elimination lamp 41, the conductive rubber roller 42, the image exposure device 44 and the developing apparatus 43 are sequentially arranged around the photoconductive drum 20 of Example 2-1, in this order in a direction of rotation (the direction of arrow R) of the photoconductive drum 20.

For the developing apparatus 43, a two-component magnetic brush developing apparatus is employed. With a developing agent in which an insulative toner with a particle diameter of around 5 μm and a conductive iron powder carrier with a particle diameter of around 60 μm are mixed, agitation and frictional charging of the toner is implemented by the two agitation screws 53. The developing agent is conveyed by these two agitation screws and the developing agent is conveyed to the set of developing rollers 51 by the magnetic roller for stirring 52. A peripheral speed of the developing rollers 51 is 1.1 times the process speed.

The semiconductive belt 56, of polyimide resin in which conductive carbon is dispersed, with a resistance value of 10⁸ to 10⁹Ω and a thickness of 200 μm, is used as the voltage supply member. In a state in which conductive rubber rollers with diameters of 30 mm are provided at two ends thereof, the conductive belt 56 presses against the photoconductive drum 20 with a total force of 1 kgf.

First, untransferred residual toner is removed from the photoconductive drum 20 by the cleaner 40, after which whole-surface exposure is performed by the optical static-elimination lamp 41, which is disposed at a rear face of the photoconductive drum 20, and surface potential of the photoconductive drum 20 (due to previous latent image charging) is reset to zero. Next, the latent image formation power source voltage Vₛ is applied to the semiconductive belt 56 which is the voltage supply member via the conductive rubber roller 42. In Example 2-1, −100 V is applied. At the second conductive rubber roller 54, +200 V is applied as the voltage for separation discharge prevention. Utilizing an LED optical system, which is the image exposure section (resolution 600 dpi, inter-dot spacing 42.5 μm), image exposure is performed in accordance with an image pattern. Accordingly, photocarriers are generated in the photoconductive layer 20D by the latent image formation voltage applied by the conductive rubber roller 42. Correspondingly, holes migrate to the surface of the photoconductive layer, holes are supplied to the charge-trapping sites, and the latent image charge is formed. When, with rotation of the photoconductive drum 20, this latent image-charged region moves away from the region of the semiconductive belt 56, because the separation discharge prevention voltage with the opposite polarity to the latent image formation voltage is being applied, increases in gap voltage during the separation are suppressed, separation discharges do not occur, and the proper latent image charge remains at the charge conservation member.

If a surface potentiometer is disposed between the voltage supply member 56 and developing rollers 51 of the present Example and the latent image potential is measured, a latent image potential of about 650 volts is obtained. This value is the same as a latent image potential of the conventional Carlson method.

Thereafter, with a developing bias of the developing apparatus 43 set to +200 V, this negative latent image is developed. Accordingly, negatively charged toner is adhered to the negative latent image portion, and an excellent toner image is provided. Thereafter, a voltage of +600 V is applied to the transfer roller 30, and the toner image is electrostatically transferred to paper. This is fixed at a fixing section (not shown) and printing is done.

### Example 2-2

Next, the photoconductive layer of the photoconductive drum 20 is structured at an a-Si photoconductor. Indium oxide is vapor-deposited on the glass substrate 20B to form the transparent conductive layer 20C, and an a-Si film is formed on the transparent conductive layer 20C by vapor phase epitaxy to form the photoconductive layer 20D to 16 μm. Thereafter, the microscopic isolated island-form electrodes 20E and the insulation layer are formed to 1 μm in the same manner as in Example 2-1. Using this photoconductive drum 20, the same tests are performed as in Example 2-1. However, because the photoconductor is positively charged on this occasion, polarities of the applied voltages and the like are reversed in this execution. Results similar to the results of Example 2-1 are obtained.

### Example 2-3

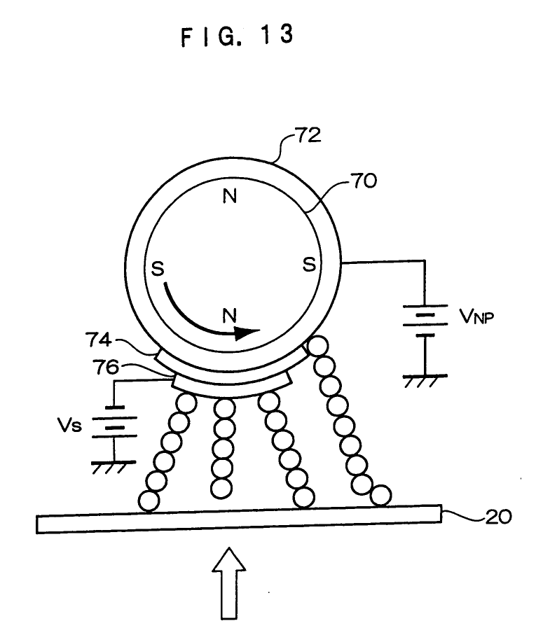

As the voltage supply member, in place of the semiconductive belt 56 of Example 2-1, a developer constituted with only a conductive magnetic carrier with a particle diameter of around 60 μm is employed. As shown in FIG. 13, an aluminium fixed sleeve 72, which is constituted by a metal sleeve, is provided at a rotatable magnetic roller 70 (diameter 60 mm). On this fixed sleeve 72, a strip-form insulation film 74 (width 10 mm by length 460 mm) is provided and, thereon, a strip-form conduction layer 76 (width 3 mm by length 460 mm) is further provided. The latent image formation voltage Vₛ is applied to the conduction layer 76, and the developing apparatus 43 is employed with a structure which provides the separation discharge prevention application voltage V_{ND} to the fixed sleeve 72.

This voltage supply member is substituted into the second embodiment, and tests are performed. At such a time, similar results to the second embodiment can be obtained.

In the case of Example 2-3, it is possible for the latent image formation section to have one developing roller. Consequently, there is an advantage of size reduction.

The embodiment of the present invention has been devised with consideration to the fact that, in order to increase latent image charge amounts for improving contrast, according to the aforementioned equation (3), it may be sufficient to raise toner charging amounts, that is, to greatly reduce developing toner amounts in a first developing process (a first step) and, after trapped charges of sufficient magnitude have been formed, form an image by a second developing process (a second step).

In the embodiment of the present invention, the charge conservation member is provided with the microscopic isolated island-form charge sites, which are formed by the numerous microelectrodes which may be capable of charge conservation being distributed more finely than individual pixels. In a state in which the voltage supply member is contacted with the microscopic isolated island-form charge sites of the charge conservation member, voltage is applied between the transparent conductive substrate and the voltage supply member, forming an electric field in the charge conservation member. While the electric field is formed in the voltage conservation member, image exposure is performed in accordance with an image pattern, from the transparent conductive substrate side of the charge conservation member, and an electrostatic latent image is formed at the microscopic isolated island-form charge sites. Thus, with the embodiment of the present invention, in the first developing process, the electric field is formed at the microscopic isolated island-form charge sites, that is, at electrode vicinities, without development with charged toner, and the image exposure is performed in accordance with the image pattern in the state in which the electric field has been formed. Accordingly, photocarriers are formed inside the charge conservation member, which is a photoconductor, these photocarriers reach the microscopic isolated island-form charge sites via the photoconductive layer, and potentials of the transparent conductive substrate and the microscopic isolated island-form charge sites are made equal. Thus, charge is supplied from a power source voltage to an insulator of the photoconductor, capacitance of which is near infinite, and trapped charges of sufficient magnitude are formed. Thereafter, it may be possible to form an image by a second developing process (second step), and it may be possible to achieve a latent image contrast at least as high as with the Carlson method.

With the aspect of the present invention, when the microscopic isolated island-form charge sites which are conductive trapping sites are provided at the charge conservation member and a voltage is applied in a first step, the conductive trapping sites could be charged by the applied voltage even where there is no image exposure. In order to avoid this, an insulation layer, may be provided at a surface of the microscopic isolated island-form charge sites. In other words, in the aspect of the present invention, it may be possible to employ a charge conservation member which includes a transparent conductive substrate, a photoconductive layer formed on the transparent conductive substrate, microscopic isolated island-form charge sites, at which numerous microelectrodes which may be capable of charge conservation are formed on the photoconductive layer to be distributed more finely than individual pixels, and an insulation layer formed on the microscopic isolated island-form charge sites.

In a case in which the insulation layer is formed on the microscopic isolated island-form charge sites, in the state in which the voltage supply member is touching the insulation layer, the voltage is applied between the transparent conductive substrate and the voltage supply member, and the electric field is formed in the charge conservation member. While the electric field is formed in the charge conservation member, image exposure corresponding to an image pattern is performed from the transparent conductive substrate side of the charge conservation member, and the electrostatic latent image is formed at the microscopic isolated island-form charge sites.

In the embodiment of the present invention, the transparent conductive substrate may formed in a circular tube form, with the photoconductive layer and the microscopic isolated island-form charge sites being formed on an outer peripheral face of the transparent conductive substrate, or the transparent conductive substrate may be formed in the circular tube form with the photoconductive layer, the microscopic isolated island-form charge sites and the insulation layer being formed on the outer peripheral face of the transparent conductive substrate

The voltage supply member of the embodiment of the present invention may be formed with a conductive rubber member or a conductive magnetic powder.

It may be preferable if the voltage applied between the transparent conductive substrate and the voltage supply member is a voltage Vₛ which will not give rise to air breakdowns between the charge conservation member and the voltage supply member. This voltage Vₛ may be set so as to satisfy either of the following equations.

$${V}_{S} < \frac{312 + 6.2 \times {10}^{6} ( \frac{L}{{ɛ}_{p}} + \frac{D}{{ɛ}_{d}} ) + \sqrt{4 \times 6.2 \times {10}^{6} \times 312 ( \frac{L}{{ɛ}_{p}} + \frac{D}{{ɛ}_{d}} )}}{( 1 + \frac{L}{{ɛ}_{p}} \cdot \frac{{ɛ}_{d}}{D} )}$$

$$\frac{{ρ}_{min}}{{ɛ}_{0} {ɛ}_{d}} D < {V}_{S} < \frac{312}{1 + \frac{L}{{ɛ}_{p}} \cdot \frac{{ɛ}_{d}}{D}}$$

Here, ρₘᵢₙ is a minimum latent image charge density required for obtaining a satisfactory image density, ε₀ is permittivity of a vacuum, L/εₚ is an equivalent thickness of the photoconductive layer, and D/ε_{d} is an equivalent thickness of the insulation layer.

A lower limit on the applied voltage Vₛ in any case is a voltage which is necessary for performing toner image formation and which is capable of providing sufficient latent image charge amounts.

Further, a separation discharge prevention power source may be further included which, when the charge conservation member and the voltage supply member are separating from the touching state, applies a separation discharge prevention voltage between the transparent conductive substrate and the voltage supply member for preventing separation discharges between the charge conservation member and the voltage supply member.

This separation discharge prevention voltage V_{ND} may be set so as to satisfy either of the following equations.

$$- {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} < {V}_{ND} < {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S}$$

Here, Vₜₕ is a air breakdown voltage.

According to an aspect of the present invention as described above, in the state in which an electric field is formed in the charge conservation member provided with the microscopic isolated island-form charge sites which are formed by the distribution of the numerous microelectrodes which are capable of charge conservation, image exposure is performed in accordance with an image pattern from the transparent conductive substrate side of the charge conservation member, and a static latent image is formed at the microscopic isolated island-form charge sites. Further, the voltage for separation discharge prevention is applied, and a separation discharge when the conductive layer is separating from the photoconductor may be prevented. Thus, image formation may be performed after trapped charges of sufficient magnitude have been formed at the microscopic isolated island-form charge sites. Therefore, it may be possible to provide a latent image contrast at least as high as with the Carlson method.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image formation device comprising:
a charge conservation member, which includes
a transparent conductive substrate,
a photoconductive layer formed on the transparent conductive substrate, and
microscopic isolated island-form charge sites, at which numerous microelectrodes which are capable of charge conservation are formed on the photocinductive layer to be distributed more finely than individual pixels;
a conductive voltage supply member, which touches the microscopic isolated island-form charge sites;
a power source for latent image formation which, in a state in which the voltage supply member touches the microscopic isolated island-form charge sites, applies voltage between the transparent conductive substrate and the voltage supply member, for forming an electric field in the charge conservation member; and
an exposure section which, in a state in which the electric field is formed in the charge conservation member, performs image exposure, in accordance with an image pattern, from the transparent conductive substrate side of the charge conservation member, for forming an electrostatic latent image at the microscopic isolated island-form charge sites.

2. An image formation device comprising:
a charge conservation member, which includes
a transparent conductive substrate,
a photoconductive layer formed on the transparent conductive substrate,
microscopic isolated island-form charge sites, at which numerous microelectrodes which are capable of charge conservation are formed on the photoconductive layer to be distributed more finely than individual pixels, and
an insulation layer formed on the microscopic isolated island-form charge sites;
a conductive voltage supply member, which touches the insulation layer;
a power source for latent image formation which, in a state in which the voltage supply member touches the insulation layer, applies voltage between the transparent conductive substrate and the voltage supply member, for forming an electric field in the charge conservation member; and
an exposure section which, in a state in which the electric field is formed in the charge conservation member, performs image exposure, in accordance with an image pattern, from the transparent conductive substrate side of the charge conservation member, for forming an electrostatic latent image at the microscopic isolated island-form charge sites.

3. The image formation device of claim 1, wherein the transparent conductive substrate is formed in a circular tube form, and the photoconductive layer and the microscopic isolated island-form charge sites are formed on an outer peripheral face of the transparent conductive substrate.

4. The image formation device of claim 2, wherein the transparent conductive substrate is formed in a circular tube form, and the photoconductive layer and the microscopic isolated island-form charge sites are formed on an outer peripheral face of the transparent conductive substrate.

5. The image formation device of claim 1, wherein the voltage supply member is formed with one of a conductive rubber member and a conductive magnetic powder.

6. The image formation device of claim 2, wherein the voltage supply member is formed with one of a conductive rubber member and a conductive magnetic powder.

7. The image formation device of claim 1, wherein a voltage Vₛ which does not cause air breakdowns between the charge conservation member and the voltage supply member is applied between the transparent conductive substrate and the voltage supply member.

8. The image formation device of claim 2, wherein a voltage Vₛ which does not cause air breakdowns between the charge conservation member and the voltage supply member is applied between the transparent conductive substrate and the voltage supply member.

9. The image formation device of claim 7, wherein the voltage Vₛ is set to satisfy the following equation:
$${V}_{S} < \frac{312 + 6.2 \times {10}^{6} ( \frac{L}{{ɛ}_{p}} + \frac{D}{{ɛ}_{d}} ) + \sqrt{4 \times 6.2 \times {10}^{6} \times 312 ( \frac{L}{{ɛ}_{p}} + \frac{D}{{ɛ}_{d}} )}}{( 1 + \frac{L}{{ɛ}_{p}} \cdot \frac{{ɛ}_{d}}{D} )}$$
in which L/εₚ is an equivalent thickness of a photoconductive layerphotoconductive layer, and D/ε_{d} is an equivalent thickness of the insulation layer.

10. The image formation device of claim 8, wherein the voltage Vₛ is set to satisfy the following equation:
$${V}_{S} < \frac{312 + 6.2 \times {10}^{6} ( \frac{L}{{ɛ}_{p}} + \frac{D}{{ɛ}_{d}} ) + \sqrt{4 \times 6.2 \times {10}^{6} \times 312 ( \frac{L}{{ɛ}_{p}} + \frac{D}{{ɛ}_{d}} )}}{( 1 + \frac{L}{{ɛ}_{p}} \cdot \frac{{ɛ}_{d}}{D} )}$$
in which L/εₚ is an equivalent thickness of a photoconductive layerphotoconductive layer, and D/ε_{d} is an equivalent thickness of the insulation layer.

11. The image formation device of claim 7, wherein the voltage Vₛ is set to satisfy the following equation:
$$\frac{{ρ}_{min}}{{ɛ}_{0} {ɛ}_{d}} D < {V}_{S} < \frac{312}{1 + \frac{L}{{ɛ}_{p}} \cdot \frac{{ɛ}_{d}}{D}}$$
in which ρₘᵢₙ is a minimum latent image charge density required for obtaining a satisfactory image density, ε₀ is permittivity of a vacuum, L/εₚ is an equivalent thickness of a photoconductive layerphotoconductive layer, and D/ε_{d} is an equivalent thickness of the insulation layer.

12. The image formation device of claim 8, wherein the voltage Vₛ is set to satisfy the following equation:
$$\frac{{ρ}_{min}}{{ɛ}_{0} {ɛ}_{d}} D < {V}_{S} < \frac{312}{1 + \frac{L}{{ɛ}_{p}} \cdot \frac{{ɛ}_{d}}{D}}$$
in which ρₘᵢₙ is a minimum latent image charge density required for obtaining a satisfactory image density, ε₀ is permittivity of a vacuum, L/εₚ is an equivalent thickness of a photoconductive layerphotoconductive layer, and D/ε_{d} is an equivalent thickness of the insulation layer.

13. The image formation device of claim 1, further comprising a separation discharge prevention power source which, when the charge conservation member and the voltage supply member are separating from the touching state, applies a separation discharge prevention voltage between the transparent conductive substrate and the voltage supply member for preventing separation discharges between the charge conservation member and the voltage supply member.

14. The image formation device of claim 2, further comprising a separation discharge prevention power source which, when the charge conservation member and the voltage supply member are separating from the touching state, applies a separation discharge prevention voltage between the transparent conductive substrate and the voltage supply member for preventing separation discharges between the charge conservation member and the voltage supply member.

15. The image formation device of claim 13, wherein the separation discharge prevention voltage V_{ND} is set to satisfy the following equation:
$$- {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} < {V}_{ND} < {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S}$$
in which Vₜₕ is a air breakdown voltage.

16. The image formation device of claim 14, wherein the separation discharge prevention voltage V_{ND} is set to satisfy the following equation;
$$- {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} < {V}_{ND} < {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S}$$
in which Vₜₕ is a air breakdown voltage.

17. An image formation process comprising:
forming an electric field in a charge conservation member which includes
a transparent conductive substrate,
a photoconductive layer formed on the transparent conductive substrate, and
microscopic isolated island-form charge sites, at which numerous microelectrodes which are capable of charge conservation are formed on
the photoconductive layer to be distributed more finely than individual pixels
or in a charge conservation member in which an insulation layer is additionally formed on the microscopic isolated island-form charge sites; and
in a state in which the electric field is formed in the charge conservation member, performing image exposure, in accordance with an image pattern, from the transparent conductive substrate side of the charge conservation member, for forming an electrostatic latent image at the microscopic isolated island-form charge sites.

18. The image formation process of claim 17, wherein a voltage Vₛ is applied between the transparent conductive substrate and a conductive voltage supply member, which is touching the insulation layer, for forming the electric field in the charge conservation member, which voltage Vₛ does not cause air breakdowns between the charge conservation member and the voltage supply member.

19. The image formation process of claim 18, wherein the voltage Vₛ is set to satisfy the following equation:
$${V}_{s} < \frac{312 + 6.2 \times {10}^{6} ( \frac{L}{{ɛ}_{p}} + \frac{D}{{ɛ}_{d}} ) + \sqrt{4 \times 6.2 \times {10}^{6} \times 312 ( \frac{L}{{ɛ}_{p}} + \frac{D}{{ɛ}_{d}} )}}{( 1 + \frac{L}{{ɛ}_{p}} \cdot \frac{{ɛ}_{d}}{D} )}$$
in which L/εₚ is an equivalent thickness of a photoconductive layerphotoconductive layer, and D/ε_{d} is an equivalent thickness of the insulation layer.

20. The image formation device of claim 19, wherein the voltage Vₛ is set to satisfy the following equation:
$$\frac{{ρ}_{min}}{{ɛ}_{0} {ɛ}_{d}} D < {V}_{S} < \frac{312}{1 + \frac{L}{{ɛ}_{p}} \cdot \frac{{ɛ}_{d}}{D}}$$
in which ρₘᵢₙ is a minimum latent image charge density required for obtaining a satisfactory image density, ε₀ is permittivity of a vacuum, L/εₚ is an equivalent thickness of a photoconductive layerphotoconductive layer; and D/ε_{d} is an equivalent thickness of the insulation layer.

21. The image formation process of claims 17, including, when the charge conservation member and the voltage supply member are separating from a touching state, applying a separation discharge prevention voltage between the transparent conductive substrate and the voltage supply member for preventing separation discharges between the charge conservation member and the voltage supply member.

22. The image formation process of claim 21, wherein the separation discharge prevention voltage V_{ND} is set to satisfy the following equation:
$$- {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S} < {V}_{ND} < {V}_{th} ( \frac{L}{{ɛ}_{p}} + \frac{D}{{ɛ}_{d}} + G ) - \frac{{ɛ}_{d}}{D} \cdot \frac{L}{{ɛ}_{p}} {V}_{S}$$
in which Vₜₕ is a air breakdown voltage.
